(19) United States
(12) Patent Application Publication
(10) Pub. No.: US 2026/0249788 A1
(43) Pub. Date: Aug. 27, 2026

(54) VEHICLE TOOL RACK ASSEMBLY WITH UNIVERSAL DRIVE SHAFT AND/OR UNIVERSAL SLIDE CAPABILITIES

(71) Applicant: IEM, INC. (d/b/a Prime Design), Eagan, MN (US)

(72) Inventors: Rashid BHARUCHA, Roseville, MN (US); Matthew HACKNER, Eden Prairie, MN (US)

(73) Assignee: IEM, INC. (d/b/a Prime Design), Eagan, MN (US)

(21) Appl. No.: 19/064,940

(22) Filed: Feb. 27, 2025

(51) Int. Cl. B60R 9/045; B60R 9/042; B60R 11/00; B60R 11/06

(52) U.S. Cl. CPC B60R 9/045; B60R 9/0423; B60R 11/06; B60R 2011/004

(57) ABSTRACT

A tool rack assembly comprises a slide assembly and/or a drive shaft assembly structured for universal use on at least two different types of vehicles. The slide assembly includes a main body portion and a slidable portion slidably engaged with the main body portion for longitudinal movement of the handle body portion relative to the main body portion to or from multiple positions of the slide assembly. The drive shaft assembly includes a removably and reversibly connectable rear shaft with a first rear shaft portion structured for use with a first type of vehicle in a first installation position, and a second rear shaft portion structured for use with a second type of vehicle in a second installation position.

### FIELD OF THE INVENTION

In various embodiments, the present invention generally relates to systems, assemblies, sub-assemblies, and tools for securing tools on a vehicle. In certain specific embodiments, the invention more particularly relates to tool rack assemblies for storing, transporting, and accessing tools in connection with vehicles such as trucks and vans.

### BACKGROUND

Commercial and consumer vehicles such as trucks and vans are used in a wide variety of business and personal tasks. Among other activities, such vehicles can be used to store and carry tools such as ladders and other heavy or unwieldy equipment. However, many conventional vehicle equipment storage systems suffer from structural and operational defects which can present problems with safely and efficiently stowing, transporting, and accessing heavy and/or bulky equipment.

Enhanced systems, assemblies, sub-assemblies, and tools are needed for securing tools on a vehicle. In particular, improved tool rack assemblies for safely and effectively retaining, moving, and accessing tools such as ladders, for example, on vehicles such as trucks and vans.

### SUMMARY

In certain aspects, the present disclosure describes a tool rack assembly comprising a slide assembly structured for universal use on at least two different types of vehicles. The slide assembly can comprise a main body portion comprising a longitudinal tubular channel and a handle portion. The handle portion can comprise: a slidable portion slidably engaged with the main body portion for longitudinal movement of the handle body portion relative to the main body portion to or from multiple positions of the slide assembly, a first slide stop block structured for resisting slidable movement of the handle portion in response to interaction of the first stop block with a first stop pin removably inserted in or attached to the main body portion. The multiple positions of the slide assembly can include: a closed or retracted position; an interim extended position in which the first slide stop block interacts with the first stop pin, the interim extended position configured for use of the slide assembly at a first height; and a further extended position in which the first slide stop block interacts with a second stop pin, with the further extended position configured for use of the slide assembly at a second height.

In other aspects of the present disclosure, a tool rack assembly can comprise a drive shaft assembly structured for universal use on different types of vehicles. The drive shaft assembly can comprise: a front shaft portion; a connecting bar removably connectable to the front shaft portion at a first end of the connecting bar; and a rear shaft removably connectable to the connecting bar at a second end of the connecting bar. The rear shaft may comprise a first rear shaft portion structured for use with a first type of vehicle in a first installation position of the rear shaft portion; and a second rear shaft portion contiguous with the first rear shaft portion and structured for use with a second type of vehicle in a second installation position of the rear shaft portion. The rear shaft portion can be reversibly connectable to the second end of the connecting bar for use with either the first type of vehicle in the first installation position or the second type of vehicle in the second installation position.

In other aspects of the present disclosure, a tool rack assembly comprises a slide assembly structured for universal use on at least two different types of vehicles, and also comprises comprising a drive shaft assembly structured for universal use on different types of vehicles.

### BRIEF DESCRIPTION OF THE FIGURES

FIGS. 1A-1C show different aspects of one example of an installation and operational environment involving a tool rack assembly installed on a vehicle.

FIG. 2 illustrates one example of a tool rack assembly structured in accordance with various aspects of the invention.

FIG. 3 illustrates another example of a tool rack assembly structured in accordance with various aspects of the invention.

FIG. 4 illustrates certain aspects of a rear shaft of a drive shaft assembly structured in accordance with various aspects of the invention.

FIG. 5 illustrates other aspects of the rear shaft of FIG. 4.

FIG. 6A illustrates an example of a handle kit.

FIG. 6B illustrates an example of a rear shaft portion to which the handle kit of FIG. 6A can be attached.

FIG. 6C shows the handle kit of FIG. 6A attached to the rear shaft portion of FIG. 6B.

FIGS. 7A-7D illustrate examples of different portions and aspects of a slide subassembly structured in accordance with certain embodiments of the invention.

FIGS. 8A-8C illustrate examples of multiple positions of a slide subassembly structured in accordance with certain embodiments of the invention

FIGS. 9 and 10 illustrate examples of certain aspects of a latch assembly which can be used in connection with a slide assembly.

FIG. 11A illustrates a view of one example of a tool rack assembly 1202 in isolation with its slide assembly in a closed or retracted position.

FIG. 11B illustrates a view of the tool rack assembly of FIG. 11A in an interim extended position.

FIG. 11C illustrates a view of the tool rack assembly of FIG. 11A in a further extended position.

FIG. 12A illustrates an example of a tool rack assembly installed on a vehicle, with the slide assembly in a closed or retracted position and retaining a piece of equipment therein.

FIG. 12B illustrates the tool rack assembly of FIG. 12A with the slide assembly in a rotated position in association with lowering the piece of equipment.

FIG. 12C illustrates the tool rack assembly of FIG. 12A with the slide assembly in a further extended position and further lowering the piece of equipment.

FIG. 13 illustrates another example of a tool rack assembly installed on a vehicle portion with a slide assembly in a retracted or closed position and securing a mounted piece of equipment therein.

### DESCRIPTION

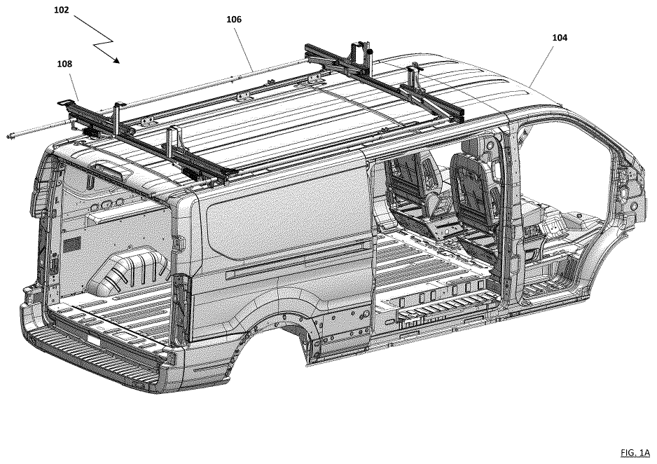

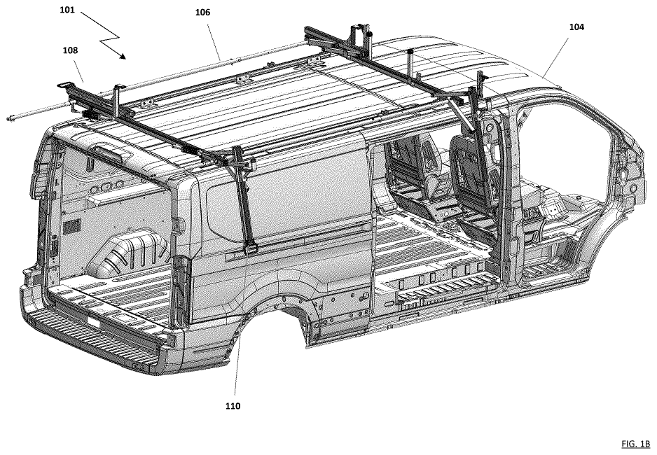

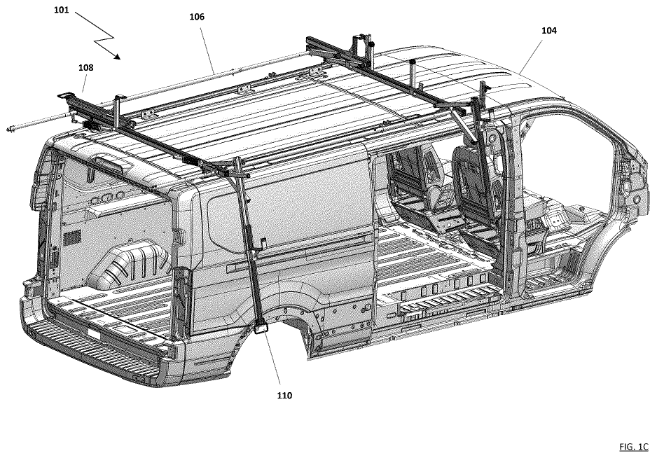

FIGS. 1A-1C show one example of an installation and operational environment in which a tool rack assembly 102 can be installed on a vehicle 104. The tool rack assembly 102 may comprise a drive shaft assembly 106 and a slide assembly 108, as shown. The tool rack assembly 102 may be used to retain various types of tools (e.g., such as a ladder (see below)) which can be secured on, transported with, and/or accessed from the vehicle 104. The vehicle 104 may be a variety of different types of vehicles such as a van (as shown), a pickup truck, and/or many other types of vehicles capable of having the tool rack assembly 102 installed thereon.

FIG. 1A illustrates a closed or retracted position of the slide assembly 108 in which a tool retained in the rack assembly 102 is stowed prior to or after use. FIG. 1B illustrates an example of an interim position of the slide assembly 108 in which a handle portion 110, for example, has been manipulated or moved into a first extended position from its previous closed or retracted position to the interim position (as shown). FIG. 1C illustrates an example of a further (and perhaps final) extended position of the slide assembly 108 in which the handle portion 110 has been manipulated or moved from the interim position to a further extended position (as shown). In this manner, a piece of equipment such as a ladder, for example, retained on the tool rack assembly 102 can be moved from a position on a roof of the vehicle 104 to an accessible position on a side of the vehicle 104.

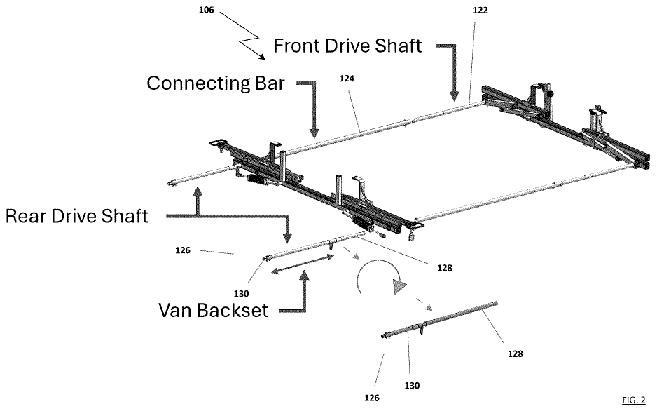

In various embodiments, and with reference to FIGS. 2 and 3, the drive shaft assembly 106 of the tool rack assembly 102 can be structured to assist with rotational movement of certain components of the tool rack assembly 102 to and from its various operational positions. FIG. 3 illustrates another example of a tool rack assembly 102A which can be installed and used in connection with a pickup truck vehicle. This rotational movement can assist with moving a piece of equipment (e.g., a ladder) from a position on a roof of the vehicle 104 to an accessible position on a side of the vehicle 104, and vice versa. The drive shaft assembly 106 can be structured for use on different types of vehicles. The assembly 106 may comprise a front shaft portion 122 and a connecting bar 124 removably connectable to the front shaft portion 122 at a first end of the connecting bar 124. A rear shaft 126 can be included in the drive shaft assembly 106 which is removably connectable to the connecting bar 124 at a second end of the connecting bar 124. The rear shaft 126 may comprise a first rear shaft portion 128 (also referred to at times as a backset) structured for use with a first type of vehicle in a first installation position of the rear shaft portion, and a second rear shaft portion 130 contiguous with the first rear shaft portion 128 and structured for use with a second type of vehicle in a second installation position of the rear shaft portion 128. The rear shaft portions 128, 130 can be removable, rotatable, and thereby reversibly connectable to the second end of the connecting bar 124 for use with either the first type of vehicle (as shown FIG. 2) in the first installation position, or the second type of vehicle (as shown in FIG. 3) in the second installation position.

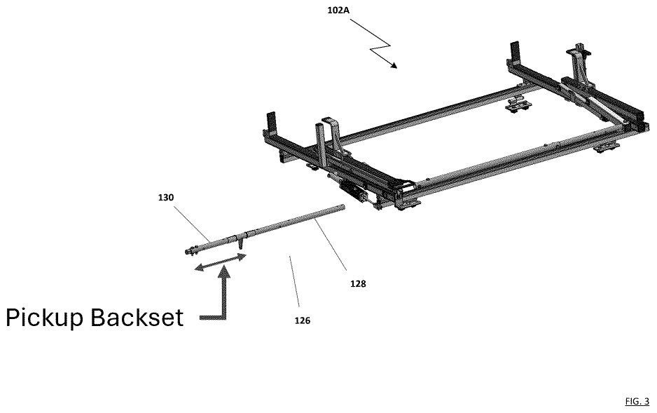

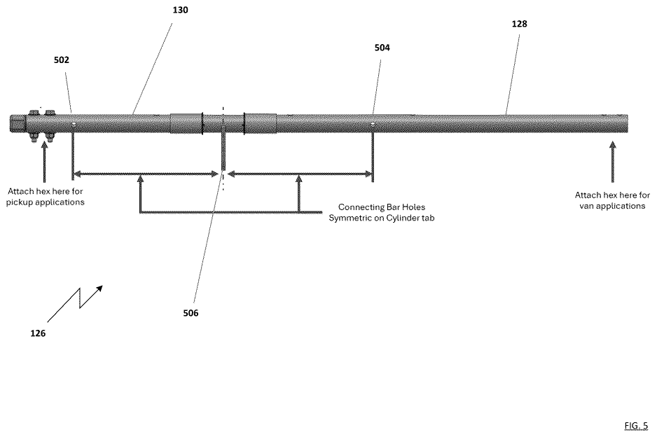

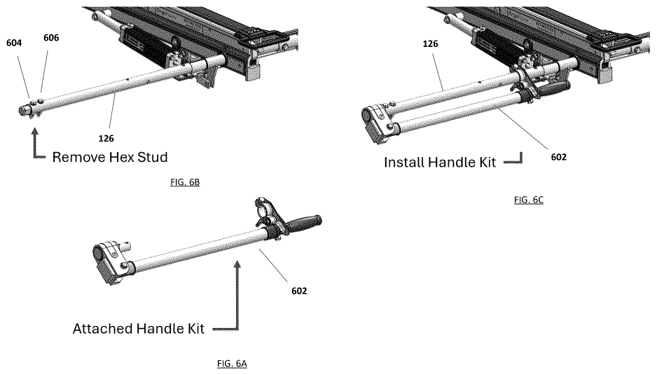

FIG. 4 illustrates aspects of the rear shaft 126 including a first connection location 402 which can be configured for attaching a rotational movement handle (see, e.g., the handle kit depicted in FIGS. 6A-6C) to the rear shaft 126 for a first type of vehicle 104 (e.g., a pickup truck). A second connection location 404 can be configured for attaching a rotational movement handle (see, e.g., the handle kit depicted in FIGS. 6A-6C) to the rear shaft 126 for a second type of vehicle 104 (e.g., a van). In this example, fastening the rotational movement handle to the rear shaft 126 can be performed using two bolt holes and corresponding hex bolt-and-nut arrangements. One or more crossbar bushings 406, 408 can be provided to facilitate insertion and removal of the rear shaft 126 in operative association with the rest of the drive shaft assembly 106.

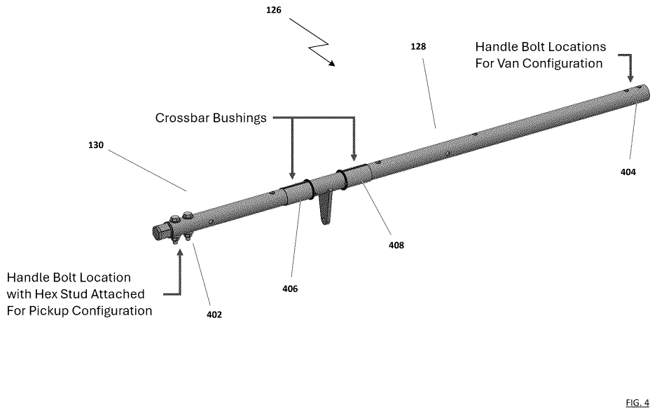

FIG. 5 illustrates aspects of the rear shaft 102 including connecting bar attachment locations 502, 504. The connecting bar attachment location 502 can be used to attach the rear shaft 126 to the connecting bar 124 when the rear shaft portion 128 is employed in connection with one kind of vehicle 104. Similarly, the connecting bar attachment location 504 can be used to attached the rear shaft 126 to the connecting bar 124 when the rear shaft portion 130 is employed in connection with another type of vehicle 104. The connecting bar attachment locations 502, 504 can be positioned to be symmetrical with respect to an axis of a cylinder tab location 506 of the rear shaft 126. In this manner, the rear shaft 126 can be readily removed, rotated, and then reversibly reinstalled using either connection location 502, 504, depending on the desired backset for the rear shaft 126, which is a function of the type of vehicle 104 on which the rear shaft is installed and used.

FIG. 6A illustrates an example of a handle kit 602 which can be attached to the rear shaft 126 shown in FIG. 6B. With hex bolts 604, 606 removed, the handle kit 602 can be attached to the rear shaft 126 as shown in FIG. 6C. As noted above, the handle kit 602 can be used to provide rotational force to manipulate portions of the slide assembly 108 of the tool rack assembly 102 into different positions to stow or retrieve equipment, for example, from the tool rack assembly 102.

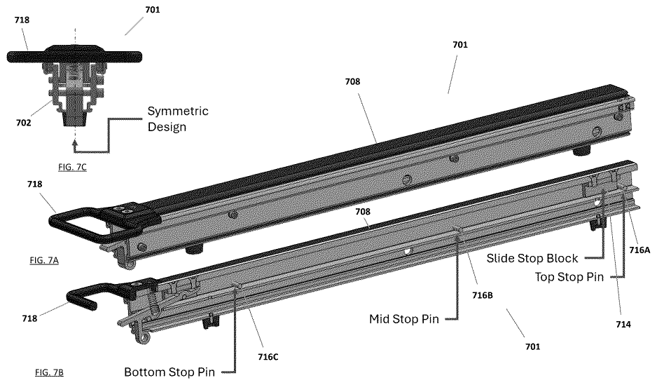

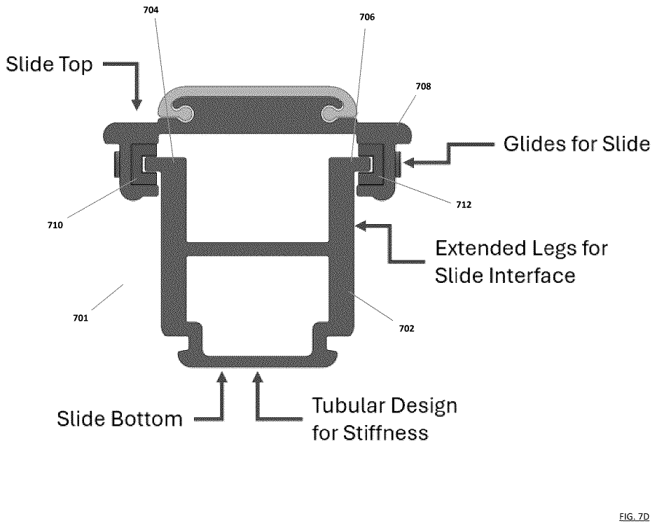

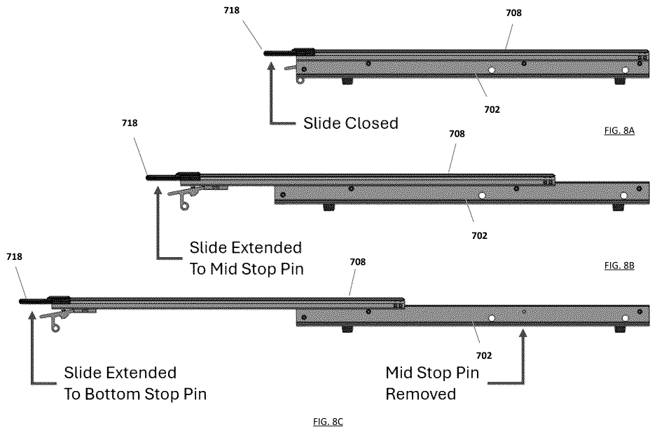

In their different views, FIGS. 7A-7D illustrate examples of different portions and aspects of a slide subassembly 701 of the main slide assembly 108. FIG. 7A illustrates an example of the subassembly 701 including a main body portion 702 comprising a longitudinal channel with extended legs 704, 706 for slidably engaging a top handle portion 708 of the subassembly 701 via guides 710, 712 (respectively). The slidable engagement involves longitudinal movement of the top handle portion 708 relative to the main body portion 702 to or from multiple positions of the subassembly 701. In the example shown, a first slide stop block 714 can be structured for resisting slidable movement of the handle portion 708 in response to interaction of the first stop block with one or more stop pins 716A-716C removably inserted into or fixedly attached to the main body portion 702. The handle portion 708 can be manually manipulated longitudinally by a hand of a user, for example, by use of a handle 718.

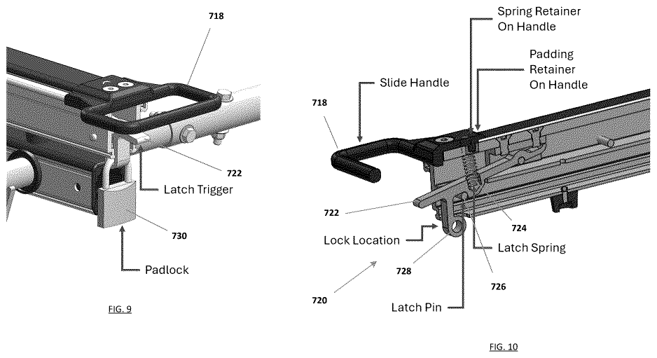

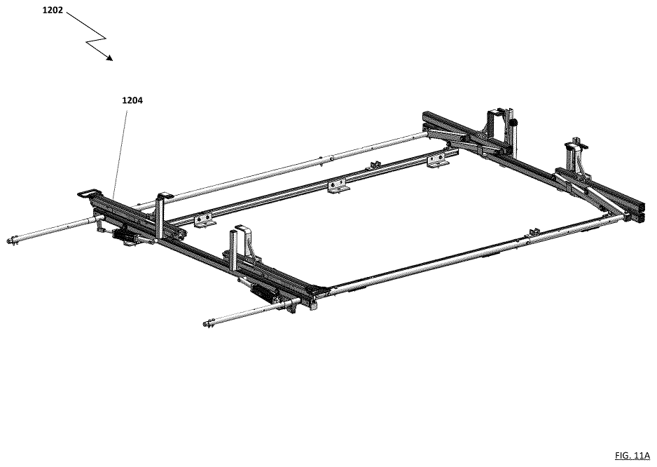

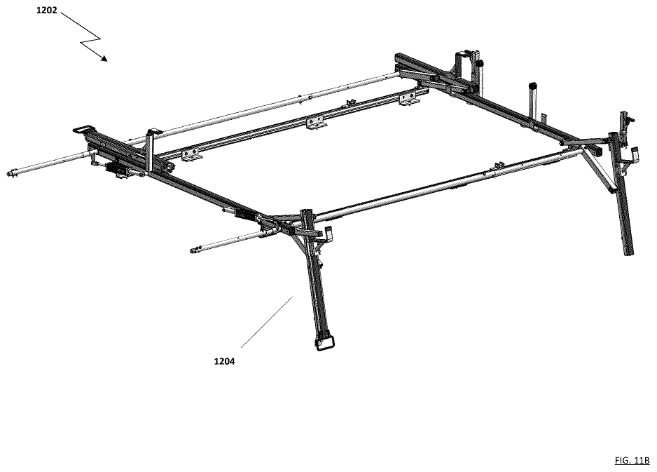

FIGS. 8A-8C illustrate examples of multiple positions of the subassembly 701 in which the handle portion 708 is extended longitudinally with respect to the main body portion 702 of the subassembly 701. FIG. 8A illustrates the subassembly 701 in a closed or retracted position of the handle portion 708, in which the stop block 714 rests against the stop pin 716A to resist further back travel of the handle portion 708. With reference to FIGS. 9 and 10, in certain embodiments, a latch assembly 720 can be provided in the subassembly 701 to enable a user to retain the subassembly 701 in the closed or retracted position. It can be appreciated that the latch assembly 720 may be useful to resist unwanted movement of the slide assembly 108, such as when the vehicle 104 is moving in transit from one location to another. For example, equipment stowed by the tool rack assembly 102 can be retained securely during such vehicle 104 transit activity. In the example shown, the latch assembly 720 may comprise a latch trigger 722 resiliently biased into a closed position by a spring 724 pressing the latch trigger 722 against a latch pin 726. The spring 724 may be a compression spring, for example, among other types of springs capable of performing substantially the same function as the spring 724 described herein. The latch pin 726 and latch trigger 722 combination thereby resist longitudinal travel of the handle portion 708 from its closed or retracted position. The latch assembly 720 may be further secured against unwanted movement by a lock 730 (e.g., a padlock) engaged at a lock location 728 of the latch assembly 720.

FIG. 8B illustrates the subassembly 701 in an interim extended position of the handle portion 708 in which the first slide stop block 714 interacts with a mid-stop pin 716B to resist further longitudinal travel of the handle portion 708 beyond the interim extended position. The interim extended position can be configured for use of the slide assembly 108 with a first type of vehicle 104, such as in response to a height of the vehicle 104 and a height at which it is desired for a user to be able to access a piece of equipment.

FIG. 8C illustrates the subassembly 701 in a further extended position of the handle portion 708 in which the first slide stop block 714 interacts with stop pin 716C to resist further longitudinal travel of the handle portion 708 beyond the further extended position. The further extended position can be configured for use of the slide assembly 108 with a second type of vehicle 104 (which may be different than a first type of vehicle 104), such as in response to a height of the vehicle 104 and a height at which it is desired for a user to be able to access a piece of equipment. It can be appreciated that additional stop blocks and/or stop pins may be employed in other configurations of the assemblies and subassemblies described herein.

It can be seen how a drive shaft assembly structured in accordance with the various embodiments as described herein can provide certain advantages and benefits. A universal drive shaft assembly can be provided which consolidates many unique driveshafts into one assembly. For example, it has the capability to perform reversibly in both van and pickup configurations (e.g., due to the reversible backset length of the rear portion), and in both righthand and lefthand configurations. As described above, its symmetrical connection location features (about the cylinder tab) provides flexibility for different installations and configurations. The drive shaft assembly also has the capability to add a handle kit in multiple configurations, if desired.

It can also be seen how a slide assembly structured in accordance with the various embodiments as described herein can provide certain advantages and benefits. Multiple interim and further extended positions allow for field adjustability of drop height. With a symmetrical design about its longitudinal axis, it can be implemented equally well for lefthanded and righthanded applications. It has an enhanced locking design including a latch assembly which can be used to release or secure movement of the slide. The tubular design of the slide assembly provides stiffness with an extended track or guide for the slide. It provides the convenience of using removable pins or fasteners as stop pins for the slide. A cast handle can provide retention for padding and improved latch assembly spring positioning. A lockable latch mechanism is designed to allow for the addition of a padlock to prevent slide movement when the padlock is in place.

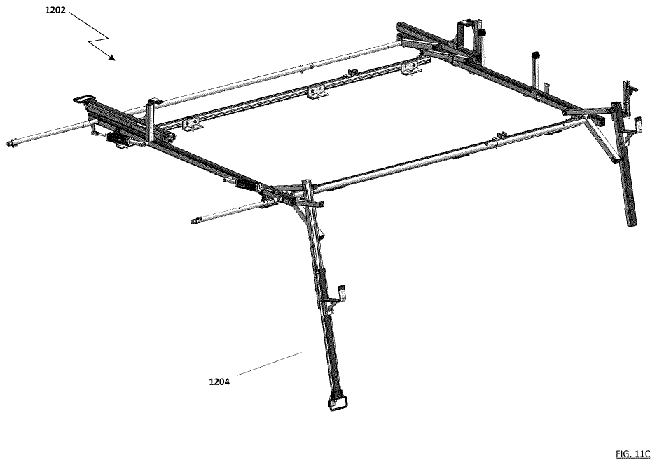

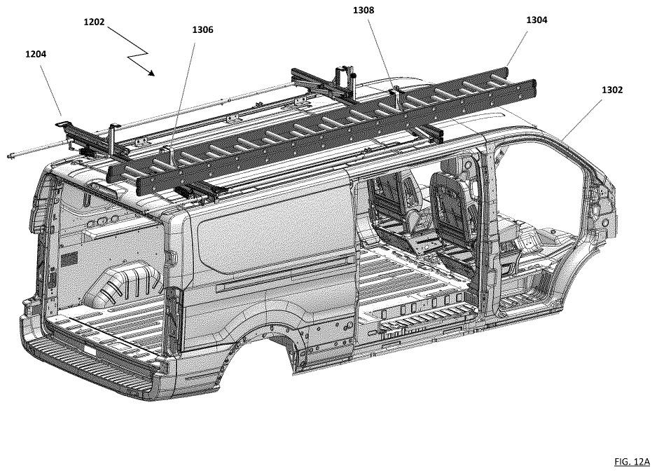

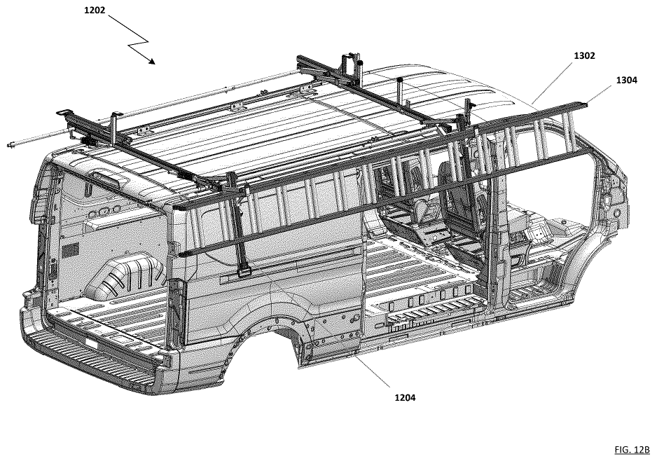

FIG. 11A illustrates a view of one example of a tool rack assembly 1202 in isolation with its slide assembly 1204 in a closed or retracted position. FIG. 11B illustrates a view of the tool rack assembly 1204 in an interim extended position. FIG. 11C illustrates a view of the tool rack assembly 1204 in a further extended position.

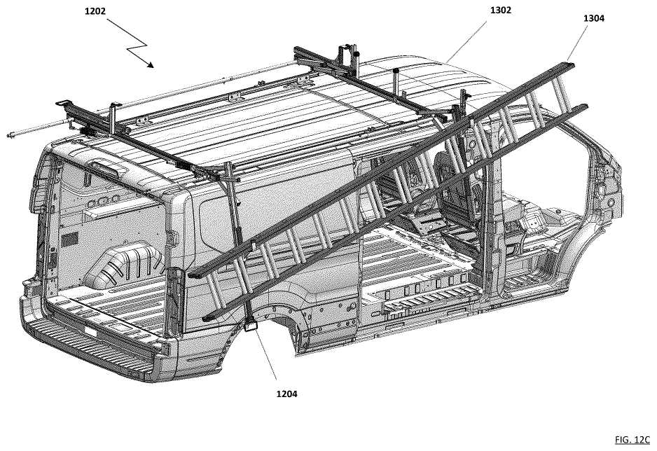

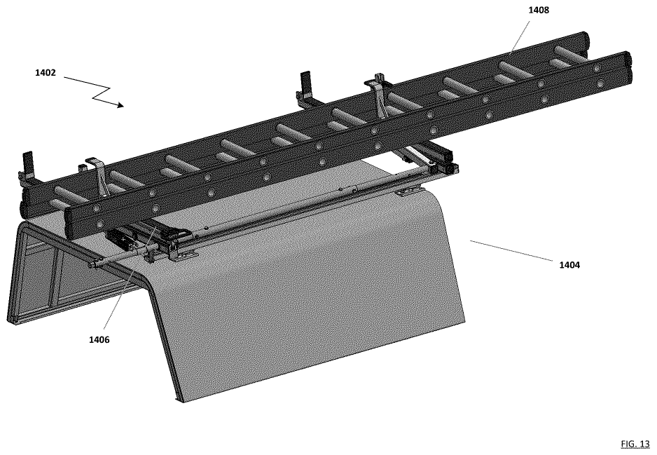

FIG. 12A illustrates an example of the tool rack assembly 1202 installed on a vehicle 1304, with the slide assembly 1204 in a closed or retracted position and retaining a piece of equipment 1304 (e.g., a ladder) therein. In this example, it can be seen that rack mounts 1306, 1308 provide structural support for receiving and retaining the equipment 1304 therein.

FIG. 12B illustrates an example of the tool rack assembly 1202 installed on the vehicle 1302, with the slide assembly 1204 in an interim extended position and lowering the piece of equipment 1304 to a first predetermined height at the side of the vehicle 1304. FIG. 12C illustrates an example of the tool rack assembly 1202 installed on the vehicle 1302, with the slide assembly 1204 in a further extended position and lowering a portion of the piece of equipment 1304 to a second predetermined height at the side of the vehicle 1302. It can be seen how determination of the first and second predetermined heights can be made based on the type of vehicle 1302 on which the assembly 1202 has been installed, the type of equipment 1304 being stored or accessed, and/or other factors.

FIG. 13 illustrates another example of a tool rack assembly 1402 installed on a vehicle portion 1404 (e.g., a canopy used in connection with a pickup truck), with its slide assembly 1406 in a retracted or closed position and securing a mounted piece of equipment 1408 therein.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system configurations or component structures described herein are necessarily intended to limit the scope of the invention, unless such aspects are specifically included in the claims.

Any element expressed herein as a means for performing a specified function is intended to encompass any way of performing that function including, for example, a combination of elements that performs that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context.

The use of any and all examples, or exemplary language (e.g., “such as” or “for example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as described and claimed herein.

What is claimed is:

1. A tool rack assembly comprising a slide assembly structured for universal use on at least two different types of vehicles, the slide assembly comprising:
a main body portion comprising a longitudinal tubular channel;
a handle portion comprising:
a slidable portion slidably engaged with the main body portion for longitudinal movement of the handle body portion relative to the main body portion to or from multiple positions of the slide assembly,
a first slide stop block structured for resisting slidable movement of the handle portion in response to interaction of the first stop block with a first stop pin removably inserted in or attached to the main body portion, and
the multiple positions of the slide assembly comprising:
a closed or retracted position,
an interim extended position in which the first slide stop block interacts with the first stop pin, the interim extended position configured for use of the slide assembly at a first height, and
a further extended position in which the first slide stop block interacts with a second stop pin, the further extended position configured for use of the slide assembly at a second height.

2. The tool rack assembly of claim 1, further comprising the main body portion comprising the longitudinal channel having one or more extended legs structured for slidably engaging at least one guide connected to the handle portion.

3. The tool rack assembly of claim 1, further comprising the handle portion structured to be manually manipulated longitudinally by either a right hand or a left hand of a user.

4. The tool rack assembly of claim 1, further comprising the slide assembly structured symmetrically about a longitudinal axis of the slide assembly to enable either right-hand or left-hand manipulation of the handle portion.

5. The tool rack assembly of claim 1, further comprising a latch assembly structured to retain the slide assembly in the closed or retracted position.

6. The tool rack assembly of claim 5, the latch assembly further comprising:
a latch trigger resiliently biased into a closed position by a compression spring pressing the latch trigger against a latch pin; and
the latch trigger and latch pin combination structured to resist longitudinal travel of the handle portion from the closed or retracted position.

7. The tool rack assembly of claim 5, further comprising a lock location structured to receive a lock therein to secure against movement of the handle portion.

8. The tool rack assembly of claim 1, wherein at least one of the vehicles comprises a truck, a pickup truck, and/or a van.

9. The tool rack assembly of claim 1, further comprising at least one mount rack portion structured for retaining a piece of equipment therein.

10. A tool rack assembly comprising a drive shaft assembly structured for universal use on different types of vehicles, the drive shaft assembly comprising:
a front shaft portion;
a connecting bar removably connectable to the front shaft portion at a first end of the connecting bar;
a rear shaft removably connectable to the connecting bar at a second end of the connecting bar, the rear shaft comprising:
a first rear shaft portion structured for use with a first type of vehicle in a first installation position of the rear shaft portion,
a second rear shaft portion contiguous with the first rear shaft portion and structured for use with a second type of vehicle in a second installation position of the rear shaft portion, and
wherein either of the rear shaft portions is reversibly connectable to the second end of the connecting bar for use with either the first type of vehicle in the first installation position or the second type of vehicle in the second installation position.

11. The tool rack assembly of claim 10, further comprising the drive shaft assembly comprising the first rear shaft portion having a first connection location configured for attaching a rotational movement handle thereto for the first type of vehicle.

12. The tool rack assembly of claim 10, further comprising the drive shaft assembly comprising the second rear shaft portion having a second connection location configured for attaching a rotational movement handle thereto for the second type of vehicle.

13. The tool rack assembly of claim 10, further comprising the drive shaft assembly comprising:
the first rear shaft portion having a first connection location configured for attaching a rotational movement handle thereto for the first type of vehicle; and
the second rear shaft portion having a second connection location configured for attaching a rotational movement handle thereto for the second type of vehicle.

14. The tool rack assembly of claim 10, further comprising the drive shaft assembly comprising a connecting bar attachment location structured to attach the first rear shaft portion to the connecting bar when the second rear shaft portion is employed in connection with the second type of vehicle.

15. The tool rack assembly of claim 10, further comprising the drive shaft assembly comprising a connecting bar attachment location structured to attach the second rear shaft portion to the connecting bar when the first rear shaft portion is employed in connection with the first type of vehicle.

16. The tool rack assembly of claim 10, further comprising the drive shaft assembly comprising:
a first connecting bar attachment location structured to attach the first rear shaft portion to the connecting bar when the second rear shaft portion is employed in connection with the second type of vehicle; and
a second connecting bar attachment location structured to attach the second rear shaft portion to the connecting bar when the first rear shaft portion is employed in connection with the first type of vehicle.

17. The tool rack assembly of claim 16, where the first and second connecting bar attachment locations are positioned symmetrically with respect each other about a cylinder tab location of the rear shaft.

18. The tool rack assembly of claim 10, wherein at least one of the vehicles comprises a truck, a pickup truck, and/or a van.

19. A tool rack assembly comprising a slide assembly structured for universal use on at least two different types of vehicles, the tool rack assembly comprising:
a slide assembly comprising:
a main body portion comprising a longitudinal tubular channel;
a handle portion comprising:
a slidable portion slidably engaged with the main body portion for longitudinal movement of the handle body portion relative to the main body portion to or from multiple positions of the slide assembly,
a first slide stop block structured for resisting slidable movement of the handle portion in response to interaction of the first stop block with a first stop pin removably inserted in or attached to the main body portion, and
the multiple positions of the slide assembly comprising:
a closed or retracted position,
an interim extended position in which the first slide stop block interacts with the first stop pin, the interim extended position configured for use of the slide assembly at a first height, and
a final extended position in which the first slide stop block interacts with a second stop pin, the final extended position configured for use of the slide assembly at a second height; and
a drive shaft assembly comprising:
a front shaft portion;
a connecting bar removably connectable to the front shaft portion at a first end of the connecting bar;
a rear shaft removably connectable to the connecting bar at a second end of the connecting bar, the rear shaft comprising:
a first rear shaft portion structured for use with a first type of vehicle in a first installation position of the rear shaft portion,
a second rear shaft portion contiguous with the first rear shaft portion and structured for use with a second type of vehicle in a second installation position of the rear shaft portion, and
wherein the rear shaft portion is reversibly connectable to the second end of the connecting bar for use with either the first type of vehicle in the first installation position or the second type of vehicle in the second installation position.

20. The tool rack assembly of claim 19, wherein at least one of the vehicles comprises a truck, a pickup truck, and/or a van.
